(19) United States
(12) Patent Application Publication
(10) Pub. No.: US 2026/0103424 A1
(43) Pub. Date: Apr. 16, 2026

(54) MAGNETIC FIELD CURABLE CONCRETE COMPOSITIONS AND METHODS OF CURING USING MAGNETIC NANOPARTICLES

(71) Applicant: CASE WESTERN RESERVE UNIVERSITY, Cleveland, OH (US)

(72) Inventors: Anna Cristina S. Samia, Beachwood, OH (US); Christian Carloni, Lakewood, OH (US)

(21) Appl. No.: 19/359,171

(22) Filed: Oct. 15, 2025

Related U.S. Application Data
(60) Provisional application No. 63/707,277, filed on Oct. 15, 2024.

(51) Int. Cl. C04B 14/30; C04B 40/02; C04B 111/00

(52) U.S. Cl. CPC C04B 14/308; C04B 40/0213; C04B 2111/00258; C04B 2111/00422; C04B 2201/50

(57) ABSTRACT

A curable concrete composition includes a curable cementitious material and a plurality of magnetic nanoparticles (MNPs) dispersed in the curable cementitious material, wherein the MNPs generate heat upon application of an electromagnetic field to the composition effective to reduce cure time of the curable concrete composition, and/or enhance mechanical strength and/or durability of a cured concrete composition formed from the curable concrete composition.

### RELATED APPLICATION

This application claims priority from U.S. Provisional Application No. 63/707,277, filed Oct. 15, 2024, the subject matter of which is incorporated herein by reference in its entirety.

### BACKGROUND

Concrete is the most widely used building material. The substitution of cement clinker with supplementary cementitious materials (SCMs), such as fly ash (FA), silica fume (SF), ground granulated blast furnace slag (GGBFS), and limestone, has become common practice in the U.S. However, the variability in chemical and phase composition of FA has limited its use as concrete producers are concerned with the quality of concrete delivered to job sites. Limestone can react with alkalis and alumina produced from the hydration of cement to generate carboaluminate phases that contribute to the development of the microstructure.

Moreover, limestone can also act as a filler, effectively reducing pores in the hydrated matrix. The percentage of limestone used as a cement substitute is usually between 10% and 30%.

GGBFS allows for a higher percentage of substitution, with studies considering up to 70%. As the percentage of GGBFS increases, the development of concrete compressive strength slows down. The amorphous aluminosilicate microstructure of GGBFS reacts slowly with water, but it is highly susceptible to thermal curing due to its high activation energy. Studies have confirmed a rapid gain in compressive strength in concrete with high GGBFS content when cured at temperatures between 40° C. and 50° C. The increase in strength is also attributed to the presence of refined pores associated with the conversion of ettringite to AFm phases.

Effective curing of concrete, especially when blended cements (BCs) are used, is vital for optimizing its mechanical strength, watertightness, and wear resistance, thereby enhancing the longevity of the fabricated structure. A rapid gain in strength can be desirable in some cases, such as in precast applications or when accelerated curing is needed, as it can reduce construction costs or the repair time of a structure. Furthermore, heat curing becomes paramount when the concrete mix includes a high volume of supplementary cementitious materials (SCMs), such as fly ash (FA) and ground granulated blast furnace slag (GGBFS), as these materials depend on the pozzolanic reaction of the SCMs to improve their mechanical and durability performance. In adverse cold weather environments, where moisture loss and freezing temperatures can significantly hinder hydration, heat curing becomes a crucial method for mitigating cracking, preventing strength loss, and accelerating the curing process. In space applications, concrete curing presents additional challenges, including moisture evaporation under vacuum conditions and extreme temperature fluctuations. Without an internal heat source, prolonged exposure to cold or severe thermal cycling in space can lead to uneven expansion, microcracking, and material degradation over time.

### SUMMARY

Embodiments described herein relate to curable concrete compositions that include magnetic particles (MNPs). The MNPs can be activated by an alternating magnetic field (AMF) to generate heat, enabling precise temperature control over the concrete curing process to reduce cure time of the curable concrete composition, and/or enhance mechanical strength and/or durability of a cured concrete composition. When exposed to an AMF, the MNPs generate heat through Néel and Brownian relaxation mechanisms. Néel relaxation occurs as the magnetic moment of the MNPs rapidly flips within the crystalline structure, while Brownian relaxation involves the physical rotation of the MNPs within the fluid phase, both dissipating energy as heat. AMF-activated MNP curing enables precise control over internal concrete temperatures during an initial setting or hardening phases or at any desired time while in service and represents a transformative advancement in concrete technology, addressing critical curing limitations in cold and space environments while enabling adaptive thermal management throughout a structure's lifespan. Moreover, the surface chemistry of MNPs can be modified so that the MNPs can function as nucleation sites or enhance bonding with hydration products, providing a dual functionality of improving cement hydration and pozzolanic activity while serving as a distributed heat source for internal curing or post-initial curing heat activation. By optimizing the curing process, we can further promote the utilization of supplementary cementitious materials (SCMs) as partial replacements for cement, contributing to coal and steel industry waste management and resource efficiency within a circular economy framework. This curing technology can be highly beneficial for bridge construction, pavements, cold weather concreting, repair, 3D printing, and space applications.

In some embodiments, a curable concrete composition includes a curable cementitious material and a plurality of magnetic nanoparticles (MNPs) dispersed in the curable cementitious material. The MNPs generate heat upon application of an electromagnetic field to the composition effective to reduce cure time of the curable concrete composition, and/or enhance mechanical strength and/or durability of a cured concrete composition formed from the curable concrete composition.

In some embodiments, the curable concrete composition includes about 0.001% to about 5% by weight MNPs, preferably about 0.002% to about 4%, about 0.005% to about 3%, about 0.007% to about 2%, about 0.01% to about 1.5%, about 0.05% to about 1%, or about 0.1% to about 1% by weight MNPs.

In some embodiments, the MNPs after application of the electromagnetic field maintain their superparamagnetic behavior without remanence.

In some embodiments, the MNPs can have a spherical or non-spherical shape, preferably a non-spherical anisotropic shape, such as a plate shape, a rod shape, a cubic or cuboid shape, an inequilateral cuboid shape, a pseudo-cubic shape, a cylindrical shape, a trapezoidal shape, a triangular pyramid shape, or other polygonal shape, more preferably a cubic or cuboid shape.

In some embodiments, the MNPs can have a spinel crystal structure.

In some embodiments, the MNPs can have an average diameter of about 10 nm to about 30 nm.

In some embodiments, the MNPs can include iron oxide MNPs, which are optionally doped with zinc, preferably iron oxide magnetic nanocubes, which are optionally doped with zinc.

In some embodiments, the MNPs can include at least one of magnetite (Fe₃O₄) or zinc-doped magnetite (ZnₓFe₃₋ₓO₄), where 0<x≤1.

In some embodiments, the MNPs can be surface functionalized with one or more ligands to enhance pozzolanic reactions with the curable cementitious material and facilitate intermolecular interactions with cementitious hydration products of the composition. For example, the MNPs can be surface functionalized with amine, carboxylic acid, or silane terminating ligands.

In some embodiments, the MNPs can include cubic-shaped MNP nano-chains, preferably hydrothermally carbonized MNP nano-chains.

In some embodiments, the curable concrete composition can further include an aggregate material dispersed in the curable cementitious material.

In some embodiments, the curable cementitious material can include at least one of cement, a supplementary cementitious material, or an alkali activatable material.

In some embodiments, the supplementary cementitious material can include at least one of fly ash, ground granulated blast furnace slag, silica fume, metakaolin, natural pozzolans, rice husk ash, sewage sludge ash, calcined clays, waste glass powders, ceramic waste, or coal bottom ash.

In some embodiments, the supplementary cementitious material can provide a source of at least a portion of the MNPs in the composition.

Other embodiments described herein relate to concrete formed using the curable concrete composition as described herein that includes a plurality of MNP inclusions.

In some embodiments, the concrete includes an aggregate material dispersed in and bound together by the cured cementitious material.

In some embodiments, the concrete is configured to be at least partially cured by magnetic heating of the MNP inclusions.

In some embodiments, the curable cementitious material can include at least one of a cured cement, supplementary cementitious material, or alkali activatable material.

Other embodiments described herein relate to a method of modulating curing of a curable concrete composition. The method includes dispersing a plurality of magnetic nanoparticles (MNPs) in a curable concrete composition, wherein the MNPs generate heat upon application of an electromagnetic field. An electromagnetic field is applied to the curable concrete composition effective for the dispersed MNPs to generate heat and at least partially cure the curable concrete composition.

In some embodiments, the electromagnetic field is an alternating magnetic field (AMF) that is applied at a magnetic field amplitude and frequency effective to heat the curable concrete composition to a temperature up to about 70° C., preferably about 40° C. to about 60° C.

In some embodiments, the alternating magnetic field is applied at a magnetic field amplitude of about 1 kA/m to about 500 kA/m and a frequency of about 100 kHz to about 1 MHz.

In some embodiments, the curable concrete composition can include a curable cementitious material (e.g., cement and optional supplementary cementitious material), an aggregate, and optionally water.

In some embodiments, the MNPs are dispersed in water and the dispersion of MNPs and water is mixed with the curable cementitious material and an aggregate to disperse the MNPs in the curable concrete composition.

In some embodiments, the MNPs are dispersed in the curable concrete composition at an amount of about 0.001% to about 5% by weight MNPs, preferably about 0.002% to about 4%, about 0.005% to about 3%, about 0.007% to about 2%, about 0.01% to about 1.5%, about 0.05% to about 1%, or about 0.1% to about 1% by weight MNPs.

In some embodiments, after application of the electromagnetic field, the MNPs maintain their superparamagnetic behavior without remanence.

In some embodiments, the MNPs can have a spherical or non-spherical shape, preferably a non-spherical anisotropic shape, such as a plate shape, a rod shape, a cubic or cuboid shape, an inequilateral cuboid shape, a pseudo-cubic shape, a cylindrical shape, a trapezoidal shape, a triangular pyramid shape, or other polygonal shape, or more preferably, a cubic or cuboid shape.

In some embodiments, the MNPs can have a spinel crystal structure.

In some embodiments, the MNPs can have an average diameter of about 10 nm to about 30 nm.

In some embodiments, the MNP can include iron oxide MNPs, which are optionally doped with zinc, preferably iron oxide magnetic nanocubes, which are optionally doped with zinc.

In some embodiments, the MNPs include at least one of magnetite (Fe₃O₄) or zinc-doped magnetite (ZnₓFe₃₋ₓO₄), where 0<x≤1.

In some embodiments, the MNPs are surface functionalized with one or more ligands to enhance pozzolanic reactions with the curable cementitious material and facilitate intermolecular interactions with cementitious hydration products of the composition. For example, the MNPs can be surface functionalized with amine, carboxylic acid, or silane terminating ligands.

In some embodiments, the MNPs can include cubic shaped MNP nano-chains, preferably hydrothermally carbonized MNP nano-chains.

In some embodiments, the supplementary cementitious material can include at least one of fly ash, ground granulated blast furnace slag, silica fume, metakaolin, natural pozzolans, rice husk ash, sewage sludge ash, calcined clays, waste glass powders, ceramic waste, or coal bottom ash.

In some embodiments, the supplementary cementitious material can provide a source of at least a portion of the MNPs dispersed in the curable concrete composition.

### BRIEF DESCRIPTION OF THE DRAWINGS

FIG. 1 is a schematic illustration of a blended cement mortar and concrete with magnetic nanoparticle inclusion.

FIG. 2 illustrates a schematic illustration of the hydrothermal carbonization (HTC) process used to coat self-assembled MNP chains with carbon.

FIG. 3(A-B) illustrate (A) pXRD patterns and (B) corresponding Rietveld analysis of rust from corroded steel pipes and synthesized MNP samples, demonstrating the complete conversion of all iron oxide crystal phases in the rust sample into the desired magnetic magnetite (Fe₃O₄) phase.

FIG. 4 is a schematic of a mixing and casting procedure of a curable concrete composition in accordance with an embodiment.

FIG. 5 is a flow diagram illustrating a curing process of the curable concrete composition in accordance with an embodiment.

FIG. 6 illustrates a schematic of a magnetic hyperthermia system in accordance with an embodiment.

FIG. 7(A-C) illustrate images of (A) Magnetic hyperthermia system described herein used for AMF activation, and (B) Photograph and (C) corresponding thermal image of a 50-mm mortar sample containing 0.1 % wt. of MNPs.

FIG. 8(A-D) illustrate (A) a TEM image of the cubic-shaped MNPs synthesized as described herein and (B) their corresponding heat curves at varying concentrations upon excitation with an AMF at a frequency of 380 kHz and field amplitude of 15 kA/m. (C) TEM image of an amino-silane ligand exchanged MNPs, confirming no change in particle morphology, and (D) their corresponding FTIR spectra with different types of ligands, verifying successful surface modification.

FIG. 9 illustrates graphs showing compressive strength test results of 7-day-old OPC-FA and OPC-GGBFS 50-mm mortar cubes, comparing specimens with and without 1.0 % wt. MNPs, respectively

FIG. 10(A-B) illustrates a graph and plot showing (A) compressive strength test results of 1-day-old OPC-FA 50-mm mortar cubes containing 0.1 % wt. MNPs, comparing specimens with and without AMF activation (380 kHz, 15 kA/m), and (B) AMF curing regimen of the specimen.

### DETAILED DESCRIPTION

For convenience, certain terms employed in the specification, examples, and appended claims are collected here. Unless defined otherwise, all technical and scientific terms used herein have the same meaning as commonly understood by one of ordinary skill in the art to which this application belongs.

The articles “a” and “an” are used herein to refer to one or to more than one (i.e., to at least one) of the grammatical object of the article. By way of example, “an element” means one element or more than one element.

The terms “comprise,” “comprising,” “include,” “including,” “have,” and “having” are used in the inclusive, open sense, meaning that additional elements may be included. The terms “such as”, “e.g.,”, as used herein are non-limiting and are for illustrative purposes only. “Including” and “including but not limited to” are used interchangeably.

The term “or” as used herein should be understood to mean “and/or”, unless the context clearly indicates otherwise.

As used herein, the term “about” or “approximately” refers to a quantity, level, value, number, frequency, percentage, dimension, size, amount, weight or length that varies by as much as 15%, 10%, 9%, 8%, 7%, 6%, 5%, 4%, 3%, 2% or 1% to a reference quantity, level, value, number, frequency, percentage, dimension, size, amount, weight or length. In one embodiment, the term “about” or “approximately” refers a range of quantity, level, value, number, frequency, percentage, dimension, size, amount, weight or length ±15%, ±10%, ±9%, ±8%, ±7%, ±6%, ±5%, ±4%, ±3%, ±2%, or ±1% about a reference quantity, level, value, number, frequency, percentage, dimension, size, amount, weight or length.

As used herein, “one or more of a, b, and c” means a, b, c, ab, ac, bc, or abc. The use of “or” herein is the inclusive or.

Throughout this disclosure, various aspects of this invention can be presented in a range format. It should be understood that the description in range format is merely for convenience and brevity and should not be construed as an inflexible limitation on the scope of the invention. Accordingly, the description of a range should be considered to have specifically disclosed all the possible subranges as well as individual numerical values within that range.

For example, description of a range such as from 1 to 6 should be considered to have specifically disclosed subranges such as from 1 to 3, from 1 to 4, from 1 to 5, from 2 to 4, from 2 to 6, from 3 to 6 etc., as well as individual and partial numbers within that range, for example, 1, 2, 3, 4, 5, 5.5 and 6. This applies regardless of the breadth of the range.

The term “cement” as used herein refers to an inorganic or organic material or a mixture of inorganic and organic materials that sets, hardens, and adheres to other materials to bind them together. The cement may comprise hydraulic cement, Portland cement, Type 1L cement (Portland cement with a portion of the cement replaced with ground limestone), or a combination thereof.

The term “hydraulic cement” as used herein refers to an inorganic material or a mixture of inorganic materials that sets and develops strength by chemical reaction with water through the formation of hydrates. Examples of hydraulic cements include, but are not limited to, Portland cement, slag cement, and blended cement, or a combination thereof. Other examples of hydraulic cement include white cement, calcium aluminate cement, high-alumina cement, magnesium silicate cement, magnesium oxychloride cement, oil well cements (e.g., Type VI, VII and VIII), magnesite cements, calcium sulfoaluminate (CSA) cement, supersulfated cements, geopolymer cement, and combinations of these. Ground granulated blast-furnace slag (GGBFS) and other slags that include one or more clinker minerals may also function as hydraulic cement. They also qualify as supplementary cementitious materials (SCMs). Some highly reactive class C fly ashes have self-cementing properties and can be defined, if desired, to provide a portion of the “hydraulic cement.”

Consistent with defining GGBFS, slags, and reactive fly ashes as “hydraulic cement,” alkali-activated cements (e.g., alkali-activated class C fly ash, alkali-activated GGBFS, and the like) sometimes known as “geopolymer cements,” are also examples of “hydraulic cements.” In the case of geopolymer cements or other cements that may be deficient in calcium ions, a source of calcium and/or magnesium ions may be added to react with the CO₂ to form nano-sized mineral particles.

The term “Portland cement” as used herein refers to a type of hydraulic cement containing primarily calcium silicates. Portland cement is in the form of a finely ground powder that is manufactured by burning and grinding a mixture of limestone and clay or shale. It may have a high CaO content (e.g., about 63%), and lower amounts of SiO₂ (e.g., about 20%) and Al₂O₃ (e.g., about 6%). Portland cement may conform to ASTM C150—“Standard Specification for Portland Cement” (e.g., ASTM-C150-2021 Edition, a/k/a ASTM C150/C150M-21).

The term “concrete” as used herein is a composite material comprising cement and an aggregate that hardens over time. Concrete may be used to refer to a wet mixture or a cured mixture.

The terms “cementitious material,” “cementitious mixture,” or “cementitious composition,” are used interchangeably to refer to a composition that comprises cement and an aggregate. A cementitious material may refer to a free-flowing particulate mixture, a liquid mixture, or a cured solid mixture.

The term “concrete composition” as used herein refers to a composition that comprises a cementitious composition. Concrete composition may be used to refer to a wet mixture or a cured mixture.

The term “mortar” as used herein refers to a workable paste which hardens and comprises cement and a fine aggregate material, for example sand and/or other fine aggregates. Mortar may be used to refer to a wet mixture or a cured mixture. “Mortar” and “concrete” may be used herein interchangeably.

The terms “pozzolanic activity” or “pozzolanic behavior” are used interchangeably to refer to the ability of a pozzolan to react with calcium hydroxide. The pozzolanic activity is a measure of either the degree of reaction over time, or the reaction rate between a pozzolan and Ca²⁺ or calcium hydroxide (Ca(OH)₂, or CH in cement chemistry notation) in the presence of water. The pozzolanic activity of a material may be determined using a reactivity test.

The term “aggregate” as used herein refers to fine or course inert granular materials including, but not limited to, sand, gravel, crushed stone, rock, or a combination thereof.

The term “compressive strength” as used herein refers to the maximum compressive stress that, under an applied load, a given solid material may sustain without failure or collapse. The compressive strength of hydraulic cement mortars may be determined according to standards set by one or more international standards setting organizations, such as the American Society for Testing and Materials, International (ASTM). The compressive strength may be determined by ASTM C109-“Standard Test Method for Compressive Strength of Hydraulic Cement Mortars” (e.g., ASTMC109-2020B Edition, a/k/a ASTM C109-20B).

The terms “water-to-cement ratio” and “w/c refer to the ratio of water to hydraulic cement (e.g., Portland cement) and is typically expressed as a weight ratio. For example, a cementitious composition comprising 300 pounds of water and 400 pounds of hydraulic cement would have a water-to-cement ratio (w/c) of 0.75. The term “w/c” as used herein typically disregards and does not consider supplementary cementitious materials (SCMs) and mineral fines. The w/c does consider sulfate added to control setting of hydraulic cement and may also consider the amount of additives, such as supplemental lime and supplemental sulfate, that provide calcium and sulfate ions and which augment the calcium and sulfate ions provided by the hydraulic cement.

The terms “water-to-cementitious material ratio” and “w/cm” are typically understood to refer to the ratio of water to total cementitious material, including hydraulic cement and supplementary cementitious material(s) (SCM), but excluding unreactive mineral fines, and is typically expressed as a weight ratio. For example, a cementitious composition comprising 300 pounds of water and 600 pounds of combined hydraulic cement and SCM(s) would have an actual water-to-cementitious material ratio (w/cm) of 0.5. The “actual w/cm” as used herein is generally synonymous with the common meaning of the term “w/cm” as used by ASTM, AASHTO, EN, engineers, concrete companies, or other established standards.

The “cement factor” relates to the amount of cementitious material and/or cement paste relative to the amount of aggregate. In general and within limits, increasing the cement factor typically increases strength at a given w/cm. An increased cement factor can reduce the tendency of the cementitious composition to experience bleeding or segregation, improving workability, cohesiveness, finishability, and overall performance. However, it can also increase the propensity for plastic shrinkage, drying shrinkage, and/or autogenous shrinkage. One skilled in the art can select an appropriate cement factor in combination with the actual w/cm to yield concrete having desired performance attributes.

Embodiments described herein relate to curable concrete compositions that include magnetic particles (MNPs). The MNPs can be activated by an alternating magnetic field (AMF) to generate heat, enabling precise temperature control over the concrete curing process to reduce cure time of the curable concrete composition, and/or enhance mechanical strength and/or durability of a cured concrete composition. When exposed to an AMF, the MNPs generate heat through Néel and Brownian relaxation mechanisms. Néel relaxation occurs as the magnetic moment of the MNPs rapidly flips within the crystalline structure, while Brownian relaxation involves the physical rotation of the MNPs within the fluid phase, both dissipating energy as heat. AMF-activated MNP curing enables precise control over internal concrete temperatures during the initial setting or hardening phases or at any desired time while in service, and represents a transformative advancement in concrete technology, addressing critical curing limitations in cold and space environments while enabling adaptive thermal management throughout a structure's lifespan. Moreover, the surface chemistry of MNPs can be modified so that the MNPs can function as nucleation sites or enhance bonding with hydration products, providing a dual functionality of improving cement hydration and pozzolanic activity while serving as a distributed heat source for internal curing or post-initial curing heat activation. By optimizing the curing process, we can further promote the utilization of supplementary cementitious materials (SCMs) as partial replacements for cement, contributing to coal and steel industry waste management and resource efficiency within a circular economy framework. This curing technology can be highly beneficial for bridge construction, pavements, cold weather concreting, repair, 3D printing, and space applications.

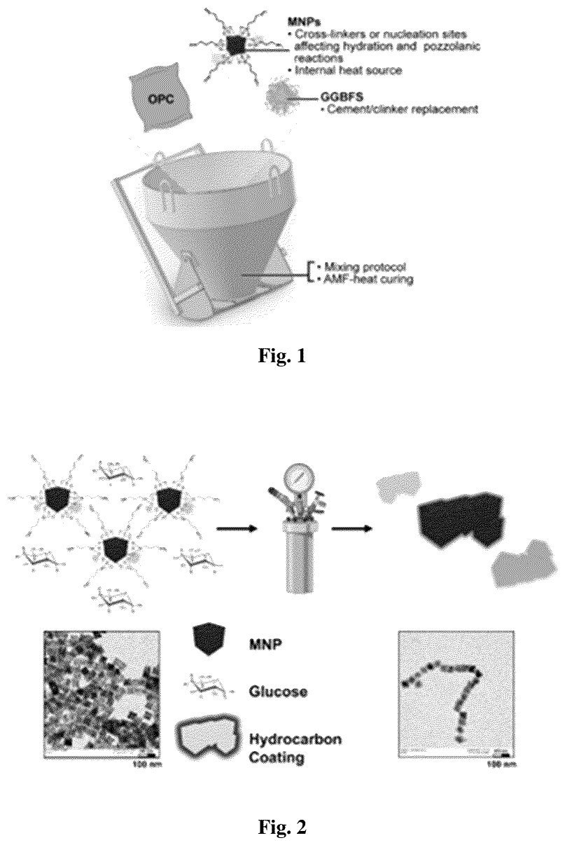

In some embodiments, a curable concrete composition includes a curable cementitious material and a plurality of magnetic nanoparticles (MNPs) dispersed in the curable cementitious material (FIG. 1). The MNPs generate heat upon application of an electromagnetic field to the composition effective to reduce cure time of the curable concrete composition, and/or enhance mechanical strength and/or durability of a cured concrete composition formed from the curable concrete composition.

The curable cementitious material can include any inorganic or organic cement or a mixture of inorganic and organic cements that set, harden, and/or adhere to other materials to bind them together. The cement can include, for example, a hydraulic cement, Portland cement, Type 1L cement (Portland cement with a portion of the cement replaced with ground limestone), or a combination thereof. In some embodiments, the curable cementitious material can include ordinary Portland cement (OPC), as defined by ASTM C-150 and which includes Types I-V cement and their variants. Types I, II, and V cements typically have a Blaine fineness between about 350-450 m²/kg (3500-4500 cm. sup.2/g). Type III cement typically has a Blaine fineness between about 450-600 m²/kg (4500-6000 cm. sup.2/g). Type 1L, 1P, and C-595 cements can also be used.

Other types of cements used in the curable cementitious materials include aluminate cements, super-sulfated cements, alkali-activated cements, geopolymer cements, and the like.

In some embodiments, the curable cementitious material can include at least about 10%, at least about 20%, at least about 30%, at least about 40%, at least about 50%, at least about 60%, at least about 70%, at least about 80%, or at least about 90%, cement by weight.

For example, the curable cementitious composition can include about 10% to about 95%, about 15% to about 90%, about 20% to about 85%, about 25% to about 80%, or about 30% to about 75%, cement by weight.

Optionally, at least a portion of the curable cementitious material can include a “supplementary cementitious material” or “SCM”. The SCM can include materials commonly used in the industry as partial replacements for Portland cement in concrete, mortar, and other cementitious materials, either in blended cements or by self-blending by end users. Examples of supplementary cementitious materials include moderate to highly reactive materials with both cementitious and pozzolanic properties, such as ground granulated blast-furnace slag (GGBFS), Class C fly ash, and steel slag, moderate to highly reactive pozzolanic materials, such as silica fume and activated metakaolin, and low to moderately reactive pozzolanic materials, such as Class F fly ash, volcanic ash, natural pozzolans, trass, calcined shale, calcined clay, and ground glass. Through alkali activation, it is possible for some SCMs to become hydraulically reactive. In a sense, the pozzolanic reaction is a form of alkali activation, albeit by less basic and/or lower soluble calcium ions as compared to more basic and/or higher soluble sodium or potassium ions as in typical geopolymer cements.

In some embodiments, the supplementary cementitious material can include at least one of fly ash, ground granulated blast furnace slag, silica fume, metakaolin, natural pozzolans, rice husk ash, sewage sludge ash, calcined clays, waste glass powders, ceramic waste, or coal bottom ash.

In some embodiments, the curable cementitious material can include at least about 0.5%, about 0.5% to about 80%, about 1% to about 75%, about 5% to about 70%, about 10% to about 60%, about 15% to about 55%, about 20% to about 50%, about 25% to about 45%, about 30% to about 40%, or about 80% by weight replacement of cement with the SCM.

In some embodiments, the curable concrete composition may comprise at least about 2%, about 2% to about 80%, about 5% to about 75%, about 10% to about 70%, about 15% to about 65%, about 20% to about 60%, about 25% to about 55%, about 30% to about 50%, about 35% to about 45%, or about 80% curable cementitious material by weight.

In some embodiments, the magnetic nanoparticles (MNPs) dispersed in the curable cementitious material can include any MNP that is capable of generating heat upon application of an alternating magnetic field (AMF) to the MNPs and promote curing of the curable cementitious material.

In some embodiments, the MNPs can include iron oxide or magnetite MNPs. The iron oxide MNPs can be highly magnetic but still maintain their superparamagnetic behavior (i.e., no remanence) to allow efficient magnetic field-induced heating. For magnetite (Fe₃O₄) MNPs, this means that the MNPs can have an average diameter or size of, for example, about 1 nm to about 50 nm, about 5 nm to about 40 nm, or about 10 nm to about 30 nm.

With an increase in MNP size and loading, the magnetization also increases; however, larger MNPs have been shown to influence crystallization sites in the host matrix materials and resulting in undesired brittleness. To overcome possible restrictions with MNP size and loading, the chemical composition of the iron oxide MNPs can be modified. By selecting Zn²⁺ as a dopant, which has no magnetic moment and has a tetrahedral site preference, an increase in the magnetization of the magnetite MNP can be achieved for a given particle size.

In some embodiments, the MNPs can include iron oxide MNPs, which are optionally doped with zinc. For example, the MNPs can include at least one of magnetite (Fe₃O₄) or zinc-doped magnetite (ZnₓFe₃₋ₓO₄), where 0<x≤1.

Therefore, in some embodiments, the MNPs can have a spherical or non-spherical shape, preferably a non-spherical anisotropic shape, such as a plate shape, a rod shape, a cubic or cuboid shape, an inequilateral cuboid shape, a pseudo-cubic shape, a cylindrical shape, a trapezoidal shape, a triangular pyramid shape, or other polygonal shape, or more preferably a cubic or cuboid shape.

The heating efficiency of MNPs shows dependence on the crystalline anisotropy, and one route to tune the heating performance is to optimize the shape anisotropy. Along this line, cubic-shaped MNPs with and without Zn-doping can be synthesized and have a higher magnetization compared to their spherical counterparts. It has been demonstrated theoretically that cubic MNPs have lower surface anisotropy compared to spheres due to a smaller amount of disordered spins as a result of the flat surface of the cube and the fact that it is comprised mostly of low energy {100} crystal facets. On the other hand, the curved surface of spherical NPs leads to a more pronounced surface spin canting. We have confirmed this prediction, and we can obtain up to an 8-fold increase in the surface adsorption rate (SAR) value, which is a measure of the heating efficiency of the MNPs.

The iron oxide magnetic nanocubes, which are optionally doped with zinc, can be formed using a solvothermal synthesis process or thermal decomposition synthesis process.

The solvothermal synthesis process relies on the homogeneous crystallization of iron precursors in a sealed, pressurized environment. Here, an alcoholic solvent such as 1-octanol serves as both the reaction medium and coordinating agent, while oleic acid and a long-chain amine act as surfactants to stabilize the growing nuclei. The addition of an aldehyde, typically benzaldehyde or related aromatic derivatives, plays a critical shape-directing role by selectively binding to the crystal facets and guiding the formation of nanocubes. The mixture is transferred into an autoclave or Parr reactor and heated (e.g., about 180° C. to about 220° C.) under autogenous pressure, allowing controlled nucleation and growth in a closed system without the need for an inert atmosphere. The reaction parameters (i.e., temperature, reaction time, fill ratio, and aldehyde type) dictate the resulting size and morphology. This solvothermal route provides high reproducibility, uniform particle shape, and scalability to gram-level yields, making it ideal for producing monodisperse iron-oxide nanocubes or Zn-doped ferrite nanocubes with enhanced magnetic properties.

Thermal-decomposition synthesis involves the pyrolytic breakdown of organometallic iron precursors in high-boiling organic solvents containing coordinating ligands such as oleic acid and amines. In this open-flask process, the metal-organic complex decomposes at elevated temperatures (typically greater than about 250° C.) to generate monodisperse nuclei, which subsequently grow into nanocrystals stabilized by the surface-bound surfactants. The solvent and ligand system controls nucleation kinetics and facet stabilization, enabling either spherical or cubic particle morphologies. Incorporation of divalent dopant precursors, such as zinc acetylacetonate yields ZnₓFe₃₋ₓO₄ nanoparticles with tunable magnetic saturation and heating efficiency. This method, which operates under atmospheric or inert conditions, produces highly crystalline, oleate-capped nanoparticles with narrow size distributions (e.g., about 20 nm to about 30 nm). Because it allows precise adjustment of composition and surface chemistry, the thermal-decomposition approach remains a benchmark route for obtaining spherical and cubic undoped or Zn-doped iron-oxide nanoparticles for hyperthermia applications.

Together, these two synthesis methods provide a versatile and scalable framework: the solvothermal process favors closed-system crystallization under moderate temperatures for high yield and cube uniformity, while the thermal-decomposition process enables fine control of morphology, dopant incorporation, and magnetic performance through both closed or open-system high-temperature chemistry.

In some embodiments, the MNPs can be surface functionalized with one or more ligands to enhance pozzolanic reactions with the curable cementitious material and facilitate intermolecular interactions with cementitious hydration products of the composition. One effective strategy is to coat or encapsulate MNPs with a silica shell. Silica-coated surfaces exhibit chemical compatibility with the cementitious matrix, which is rich in calcium silicate hydrate (C—S—H) and other silicate phases. This chemical compatibility has been demonstrated to enhance particle-matrix bonding and reduces adverse interaction

In other embodiments, the MNPs can be surface functionalized with amine, carboxylic acid, or silane terminating ligands. For silane functionalization, a facile ligand-exchange scheme can be used, which replaces the native oleate shell on the iron oxide MNPs with trialkoxysilanes bearing the desired terminal group and forms robust Fe—O—Si linkages at the nanoparticle interface. A representative, generalized procedure is (i) pre-hydrolyze the chosen silane (e.g., (3-aminopropyl)triethoxysilane, APTES for —NH₂; (3-triethoxysilyl)propylsuccinic anhydride, TESPSA for —COOH; and methyltrimethoxysilane, MTMS, for —CH₃; all from Gelest, Inc.) in a small aliquot of water at ˜70 °C.; (ii) disperse the oleate-capped magnetic iron oxide nanoparticles in dry toluene and introduce a basic alcohol/ammonia co-solvent (e.g., 1-butanol with NH₄H) plus a tertiary amine catalyst (e.g., trimethylamine) to promote silanol condensation at the oxide surface; (iii) add the hydrolyzed silane and maintain about 70° C. (in N₂ or dry air) for several hours to drive exchange and condensation; (iv) isolate by antisolvent precipitation and centrifugation, redisperse (e.g., in water), and confirm grafting by FTIR (Si—O stretch; terminal-group bands) and TGA (surface coverage typically a few molecules nm⁻²).

In this ligand-exchange process, the stronger chelating ability of the silanol groups toward surface Fe sites drives the displacement of the weaker carboxylate coordination from the native oleic acid ligand. The addition of an organic amine (trimethylamine) also plays a key mechanistic role by neutralizing the oleic acid ligand, thereby freeing the nanoparticle surface for condensation of the hydrolyzed silane molecules. After functionalization, the nanoparticles are transferred into aqueous solution, where the terminal group dictates colloidal stability: for amine-terminated surfaces, the pH is adjusted so that —NH₂ groups are protonated to —NH₃⁺, while for carboxyl-terminated surfaces, the —COOH groups are deprotonated to —COO⁻, yielding electrostatically stabilized dispersions. In contrast, the methyl-terminated surface (MTMS) is hydrophobic and retained as a control for comparison, since it provides a chemically robust, nonpolar interface analogous to the alkyl tail of oleic acid but covalently bound through siloxane anchoring.

In still other embodiments, the MNPs can include cubic-shaped MNP nano-chains, preferably hydrothermally carbonized MNP nano-chains. The formation of self-assembled MNP chains plays a crucial role in enhancing heating efficiency under an AMF. Chain-like arrangements of MNPs can leverage dipolar interactions and anisotropy effects to improve SAR compared to randomly dispersed nanoparticles. Studies have shown that when MNPs self-assemble into aligned chains, their collective magnetization switching under AMF leads to higher energy dissipation per cycle, resulting in superior heating performance.

Referring to FIG. 2, cubic-shaped Fe₃O₄ nanochains can be synthesized with tailored interfacial chemistry to enhance both heating performance and stability in cementitious composites. To achieve this, the self-assembly of cubic MNPs into linear chains can be induced, leveraging dipole-dipole interactions and external magnetic field-assisted alignment to control the length and orientation of the chains. Once assembled, the nanochains can undergo hydrothermal carbonization (HTC) using sugar-based precursors. HTC provides a scalable and environmentally friendly route to coat the MNP chains with a conformal carbon shell, stabilizing their structure while enhancing their interfacial compatibility with cementitious matrices. The carbon coating not only preserves chain alignment but also mitigates particle oxidation, improves dispersion stability, and facilitates bonding interactions with cement hydration products. The HTC process can be optimized by tuning reaction conditions (e.g., sugar concentration, reaction time, and temperature) to achieve uniform carbon shells while maintaining the desired nanochain morphology.

Introducing carbon-coated MNP nanochains into cementitious systems offers several key advantages. The carbon shell acts as a nucleation site for C—S—H formation, promoting hydration reactions and strengthening the composite structure. Carbon nanomaterials, such as graphene oxide (GO) and carbon nanotubes (CNTs), have been shown to accelerate cement hydration kinetics and improve mechanical properties by enhancing interfacial bonding and crack bridging effects. Similarly, the carbon-coated MNP chains can enhance cement matrix reinforcement, prevent nanoparticle aggregation, and contribute to the overall durability of the material. Moreover, the presence of a conductive carbon layer may enable additional functionalities, such as self-sensing or electrical conductivity enhancement, further broadening potential applications.

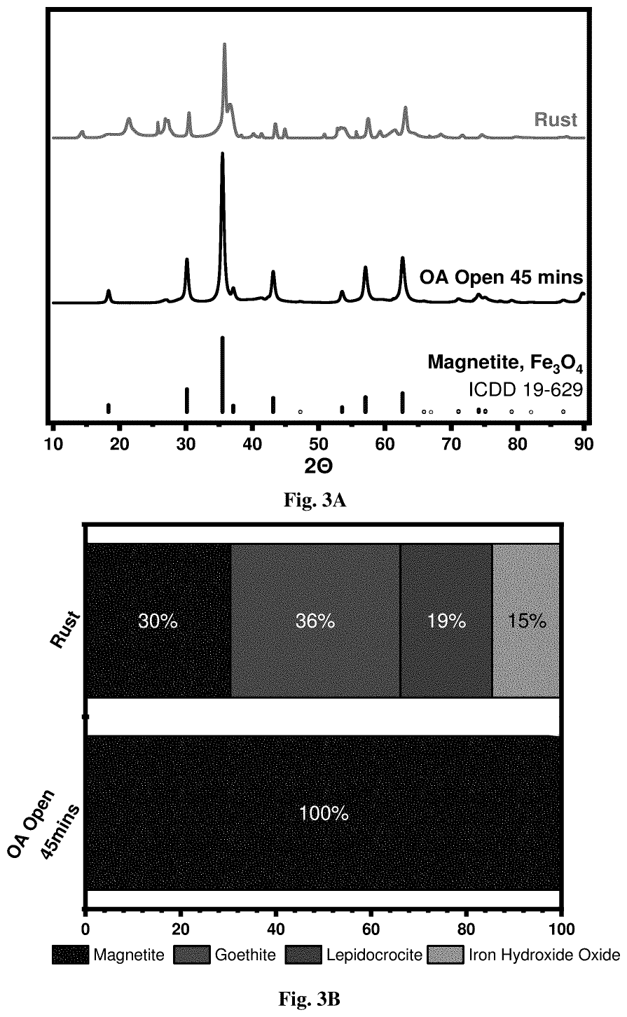

In other embodiments, the MNPs dispersed in the curable cementitious material can be formed from sustainable solid feeds, such as rust or pre-treated steel-slag powders or SCMs. For example, as illustrated in FIG. 3, an open-air, high-temperature thermal decomposition route can convert iron in the sustainable solid feeds (e.g., rust) into oleate-capped magnetite (Fe₃O₄) nanocrystals using edible high-oleic oils as the in-situ ligand source. In a typical run, the Fe-rich powder (finely ground rust; or slag that is first water-rinse and briefly acid-washed to a pH of about 4.5 to remove free CaO/Ca(OH)₂ that would otherwise form calcium oleate) is combined with excess high-oleic cooking oil (the oil thermally liberates oleic acid, which complexes Fe to form iron-oleate) in an open flask fitted with a thermocouple. The mixture is heated in ambient air to about 300° C. to about 340° C. and held at about 30 min to about 150 min (no inert atmosphere required). At these temperatures, iron-oleate forms and thermally decomposes to nucleate and grows Fe₃O₄ while the liberated oleate caps the nascent nanocrystals; phase/selective oxidation/reduction of mixed iron oxides present in the feed (e.g., FeOOH/Fe₂O₃) to Fe₃O₄ is achieved by tuning the ligand: iron ratio, peak temperature, and hold time (higher oleate: Fe and longer holds favor complete conversion and narrower size distributions, whereas lower oleate or shorter holds yield broader sizes or residual non-magnetite phases). After natural cooling, the black product is transferred with a nonpolar solvent (e.g., toluene), briefly sonicated, and washed by antisolvent precipitation (e.g., 2-3 cycles with ethanol: toluene) to remove unbound organics, then redispersed in toluene (hydrophobic stock) or subsequently phase-transferred/ligand-exchanged for use in aqueous suspensions. The method thus couples waste-derived Fe sources and ligand precursors with simple open-air processing to afford oleate-stabilized Fe₃O₄ magnetic nanoparticles with particle sizes of about 10 nm to about 30 nm and phase purity that are reproducibly controlled by the oleate: Fe stoichiometry and reaction heating profile.

In some embodiments, the curable cementitious material can include about 0.001% to about 5% by weight MNPs, preferably about 0.005% to about 5%, about 0.01% to about 5%, about 0.05% to about 5%, or about 0.1% to about 5% by weight MNPs In other embodiments, the curable concrete composition includes about 0.001% to about 5% by weight MNPs, preferably about 0.002% to about 4%, about 0.005% to about 3%, about 0.007% to about 2%, about 0.01% to about 1.5%, about 0.05% to about 1%, or about 0.1% to about 1% by weight MNPs.

The curable concrete composition can further include aggregates or aggregate materials dispersed in or with the curable cementitious material and MNPs. The aggregate materials can include fine or coarse inert granular materials including, but not limited to, mineral fines, sand, gravel, crushed stone, rock, or a combination thereof. The term “mineral fines” refers to fines of any mineral, including but not limited to, waste aggregate particles or fines, waste or manufactured limestone fines, quarry fines, shale flue dust from manufacturing lightweight calcined shale aggregates, granite fines, stone dust, rock dust, marble dust, mine tailings, pulverized bottom ashes, pulverized metallurgical slags, waste or pulverized shale from shale oil extraction, and waste or pulverized sand from tar sand extraction, ground recycled concrete, and concrete washout fines (wet or dried). Mineral fines many contain basaltic minerals, other siliceous minerals, and igneous minerals. Virtually any particulate mineral material can used as and/or processed or pulverized to be mineral fines. Unless otherwise specified, the terms “mineral fines” and “quarry fines” are understood to include “limestone powder”(e.g., ground limestone powder).

The term “limestone powder” refers to ground minerals containing mostly calcite and/or dolomite. Limestone powder is typically manufactured for use as limestone and will generally be a more pure form of the mineral with less contaminants than quarry fines or rock dust. Nevertheless, many limestone powders are produced by aggregate manufacturers that also produce quarry fines and may even be quarry fines, albeit a more pure form. Thus, limestone powder, quarry fines, and/or rock dust may be synonymous in some cases. In some cases, limestone powders are made from white limestone powders that have high brightness so that they can be used in decorative precast concrete compositions. In other cases, they can be off-white or grey.

Mineral fines may also comprise a wider range of particles and have a more gritty or sandy consistency. In such cases, a smaller proportion of mineral fines may be defined as “cementitious binder” and larger proportion defined as “aggregate.” Mineral fines of any size range can be analyzed to determine particle size distribution and apportioned between cementitious binder and aggregate using the principles disclosed herein. In general, mineral fines that are coarser and less processed are lower cost and can substitute for a relatively larger portion of aggregate to further reduce cost of the cementitious composition. Depending on the effect of coarse mineral fines on rheology and/or strength, the cutoff particle size between “cementitious binder” and “aggregate” can be higher or lower to account for such rheological and/or strength differences.

The term “coarse aggregate” generally refers to aggregate particles that are generally at least 4.75 mm ( 3/16 inch) in size, up to about 5 inches, 4 inches, 3 inches, 2 inches, 1.5 inch, 1 inch, ¾ inch, or ½ inch. The term “medium aggregate” generally refers to a subset of coarse aggregate, but of smaller average size (e.g., pea gravel, which can include particles ¼ to ½ inch in size and/or ⅛ to ¼ inch in size). Coarse aggregates can be made from any appropriate mineral, such as limestone, granite, basalt, other geological materials, and metallurgical slags. Hence, quarry fines may include any leftover fines from making coarse aggregate.

The term “fine aggregate” (e.g., sand) generally refers to aggregate particles that are generally less than 4.75 mm ( 3/16 inch) in size and retained on a screen having an appropriate mesh size. Sand (fine aggregate) can be manufactured by milling and/or removed from coarse aggregate by screening. To control consistency, fine aggregate is commonly screened using a No. 100 sieve, which retains particles of about 150 μm and larger, or a No. 140 sieve, which retains particles of about 105 μm and larger, or a No. 200 sieve, which retains particles of about 75 μm and larger. Particles that fall through the screen(s) are collected and discarded as quarry fines. Fine aggregates can be made from any appropriate mineral, such as limestone, granite, basalt, other geological materials, and metallurgical slags. Hence, mineral fines may include any leftover fines from making fine aggregate.

Aggregate materials, such as quarry fines, limestone powder, rock dust, safety mine dust, mine tailings, marble dust, stone dust, shale dust, granite fines, ground bottom ash, ground metallurgical slags, waste or pulverized shale from shale oil extraction, waste or pulverized sand from tar sand extraction, ground recycled concrete, concrete washout fines (wet or dried), and other waste or manufactured minerals can be blended with the curable cementitious material and MNPs. Aggregate materials can replace some of the cement particles, optionally some of the SCM particles, optionally some of the aggregate, provide a “paste aggregate” or filler to complement or augment the total quantity of cementitious material particles in a cement paste, increase particle packing density and paste density, provide a filler effect using a less expensive component, lower the w/cm, increase fluidity, increase strength, and reduce shrinkage and creep.

In some embodiments, it may be desirable to include an SCM fraction that is as coarse or coarser than the aggregate materials. Coarse SCMs can provide additional filler effect to increase strength, particle packing density, and paste density, reduce water demand, and provide late age pozzolanic activity. Coarse fly ash can react pozzolanically over time but may not contribute significantly to early strength. Other coarse aggregates do not react pozzolanically but can provide nucleation sites and/or form calcium carbonaluminates in order to accelerate early strength gain. Together, coarse fly ash and aggregate can boost early and late strengths.

In some embodiments, the curable concrete composition may comprise at least about 2%, about 2% to about 80%, about 5% to about 75%, about 10% to about 70%, about 15% to about 65%, about 20% to about 60%, about 25% to about 55%, about 30% to about 50%, or about 35% to about 45%, aggregate by weight.

It can be beneficial to add other supplemental materials to the curable concrete composition. Such other supplemental materials can include supplemental lime. Supplemental lime can be “supplemental” to lime released during hydration of cements, such as Portland cement. Supplemental lime can be added as quicklime (CaO), hydrated lime (Ca(OH)₂) and/or Type S lime. Although quicklime is more soluble than hydrated lime, when exposed to water quicklime is converted into hydrated lime. Therefore, the solubility of hydrated lime, or calcium hydroxide, in water is generally a limiting factor for how much supplemental lime can be added before it becomes deleterious.

In general, hydrated lime (e.g., Type S lime) is readily available and easier and safer to handle than quicklime. Hydrated lime also does not consume water when mixed into a cementitious composition and therefore does not affect water demand as much as quicklime. It is also not expansive like quicklime, which expands when it hydrates. It has been found that hydrated lime typically works more predictably than quicklime, with similar or even superior results from the standpoint of early and late strength development.

In some embodiments, the amount of supplemental lime can be below, at, or above the amount required to achieve or maintain saturation in water. The amount of supplemental lime required to maintain a saturated pore solution is dependent on factors such as the amount of free lime released from the hydraulic cement during hydration, the amount of lime consumed during cement hydration and pozzolanic reactions, and the solubility of lime, which decreases with increased temperature. Increased temperature may accelerate consumption of lime, offsetting negative effects of decreased solubility. Using a more reactive pozzolan may deplete lime faster than a less reactive pozzolan. The ideal amount of supplemental lime is theoretically that amount that maintains a pore solution saturated with calcium ions over time in conjunction with lime released from the hydraulic cement and is consumed by pozzolanic reactions. A relatively small excess of supplemental lime can be added as a reservoir to provide additional lime as it is depleted.

Optionally, when there is insufficient sulfate to properly react with aluminates in the cementitious material, a supplemental sulfate source can be added, such as calcium sulfate hemihydrate (plaster of Paris), calcium sulfate dihydrate (gypsum), anhydrous calcium sulfate (anhydrite), and alkali metal sulfates (e.g., lithium sulfate).

The curable concrete composition can further include water that is blended with the curable cementitious material, MNPs, aggregates, and other supplemental materials. Water is both a reactant and rheology modifier that permits a fresh curable cement composition to flow or be molded into a desired configuration. The curable cementitious material can react with water, bind the other solid components together, be most responsible for early strength development, and contribute to later strength development. Blends with high packing density have reduced void space, which reduces water demand and increases workability for a given quantity of water.

In some embodiments, the curable concrete composition can include at least about 5 wt. %, about 5 wt. % to about 20 wt. %, about 10 wt. % to about 15 wt. %, or about 20 wt. % water. The water-to-cementitious material ratio (w/cm) can greatly affect rheology and strength. In general, lowering the amount of water increases strength but negatively affects flow, requiring a superplasticizer and/or water-reducing admixture to maintain proper flow.

Thus, there is usually an inverse correlation and tradeoff between strength and rheology, all things being equal. Of course, poor rheology can also negatively affect strength if a fresh cementitious composition cannot be properly consolidated or compacted. In addition to w/cm, the “cement factor” can affect strength. The w/cm can be in any desired value in a range of about 0.2 to about 0.7. Concrete of low strength typically has a w/cm greater than about 0.55. Concrete of moderate strength can have a w/cm between about 0.45 and about 0.55. Concrete of moderately high to high strength can have a w/cm between about 0.33 and about 0.45. Concrete of high to very high strength can have a w/cm between about 0.22 and about 0.33. Ultrahigh performance concrete (UHPC) can have a w/cm between about 0.17 and about 0.25.

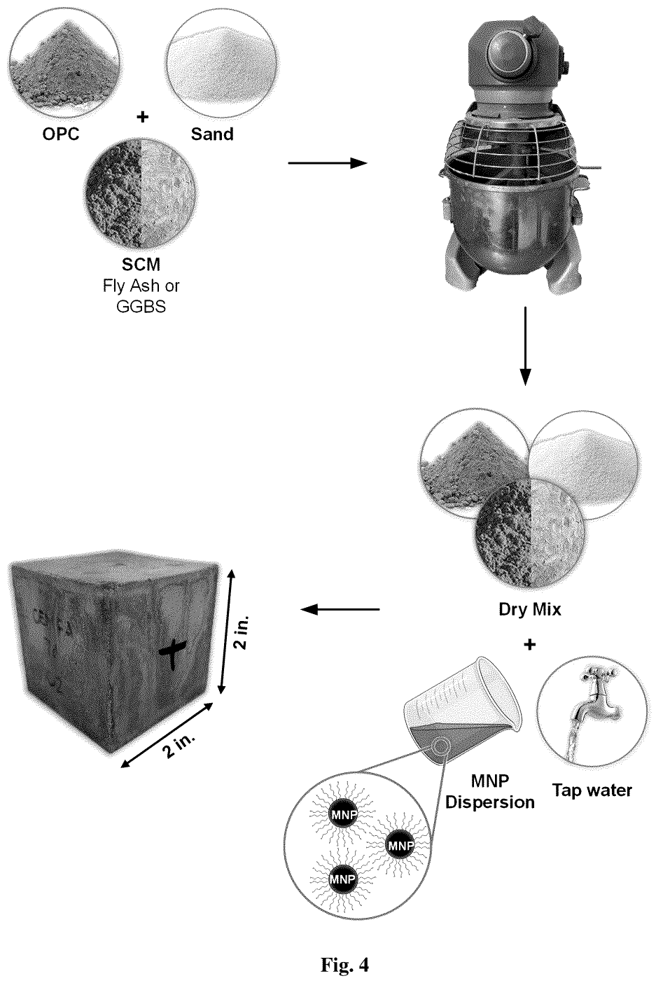

FIG. 4 illustrates a schematic of a mixing and casting procedure for forming the curable concrete composition. The curable cementitious material can be dry-blended or formed in situ when making a fresh curable concrete composition containing MNPs, water, and aggregate. The cement, SCM, and aggregate can be blended in a batch mixer to provide a dry mix. The MNPs can be dispersed in water, and the MNP water dispersion can be mixed with the dry mix. The mixture of dry mix and MNP water dispersion can then be blended with, for example, a drill mixer, to form the curable concrete composition and other cementitious compositions (e.g., moldable compositions, precast concrete, GFRC, stucco, grout, mortar and the like).

By way of example, for each batch, the cementitious materials and aggregate, e.g., sand, are first dry-mixed for 2 minutes to ensure uniform distribution. Tap water, equal to 70% of the total water content (assuming a water-to-binder ratio of 0.5), is then gradually added while continuously mixing for 5 minutes. A well-dispersed MNP suspension—prepared using 30% of the total water volume—is gradually introduced while mixing continuously for 3 minutes. To ensure homogeneity and assess workability, the mixture is then manually mixed for an additional 2 minutes. This procedure allows for the incorporation of MNPs to achieve the target weight percentage of MNPs relative to the cementitious materials.

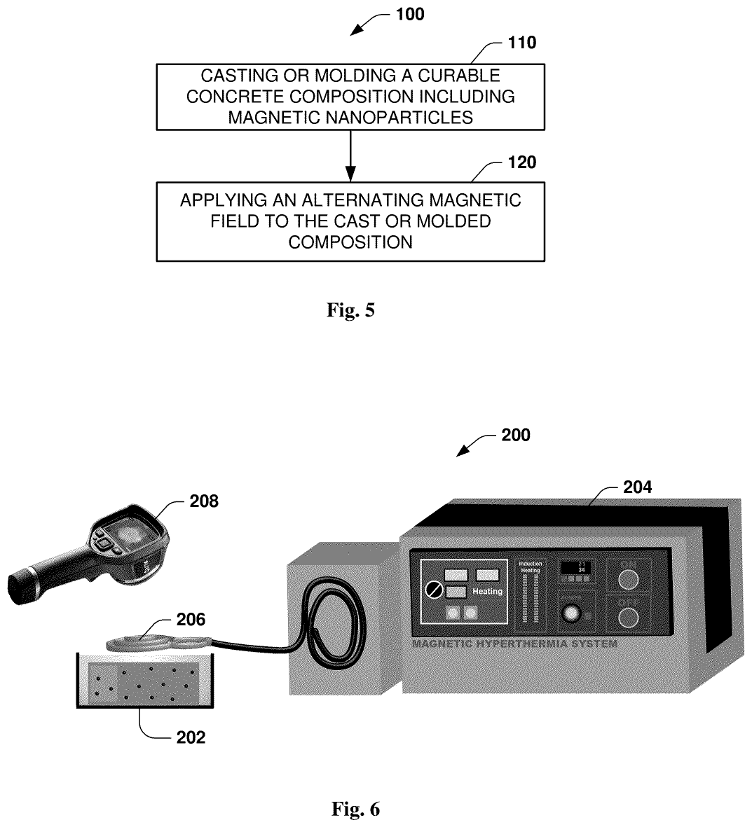

Referring to FIG. 5, which is a flow diagram of the curing process 100 for curable coating composition, at step 110, freshly mixed concrete and other curable concrete compositions are cast or typically placed into a mold while in a plastic or flowable condition. In some cases, the mold is a form, such as to make a footing, wall, pillar, piling, or other vertical structure. In the case of precast concrete, the mold can have the shape of a concrete barrier, a structural concrete shape, decorative concrete, and the like. Forms for flatwork can hold concrete within a confined area with an exposed surface, which can be finished using a trowel, screed, float, polisher, and/or other known finishing device.

The curing of the cast or molded concrete composition, including during the setup and hardening of the cast concrete or the concrete within the mold, can be modulated at step 120 by applying an alternating magnetic electric field to the cast or molded concrete composition, effective for MNPs inclusions provided by the dispersed MNPs in the concrete composition to generate heat. The AMF generation of heat by the MNP inclusions in the cast or molded concrete composition can enable precise temperature control over the concrete curing process to reduce cure time of the curable concrete composition, and/or enhance mechanical strength and/or durability of a cured concrete composition. When exposed to an AMF, the MNP inclusions generate heat through Néel and Brownian relaxation mechanisms. Néel relaxation occurs as the magnetic moment of the MNPs rapidly flips within the crystalline structure, while Brownian relaxation involves the physical rotation of the MNPs within the fluid phase, both dissipating energy as heat. The AMF can be applied continuously or cyclically to generate heat in concrete composition. AMF-activated MNP curing enables precise control over internal concrete temperatures during the initial setting or hardening phases or at any desired time while in service.

FIG. 6 illustrates a schematic diagram of a magnetic hyperthermia system 200 for applying an AMF to the cast or molded concrete composition 202 effective for MNPs inclusions to generate heat and at least to and at least partially cure the curable concrete composition. The magnetic hyperthermia system 200 includes an alternating current source 204 that generates an amount of alternating current to produce an AMF. Optionally, the alternating current source 204 can include a water cooler (not shown) to dissipate heat in the alternating current source 204. The alternating current source 204 is electrically coupled to an induction coil 206 that is positioned adjacent to the cast or molded concrete composition. The induction coil 206 transforms the alternating current into an AMF that is applied to the cast or molded concrete composition. Optionally, the magnetic hyperthermia system 200 can further include a temperature monitor 208, such as an infrared camera or temperature probe, to monitor temperature changes in the cast or molded concrete composition.

In some embodiments, the AMF can be applied at a magnetic field amplitude and frequency effective to heat the cast or molded curable concrete composition to a temperature up to about 70° C., preferably about 40° C. to about 60° C. For example, the alternating magnetic field is applied at a magnetic field amplitude of about 1 kA/m to about 500 kA/m and a frequency of about 100 kHz to about 1 MHz.

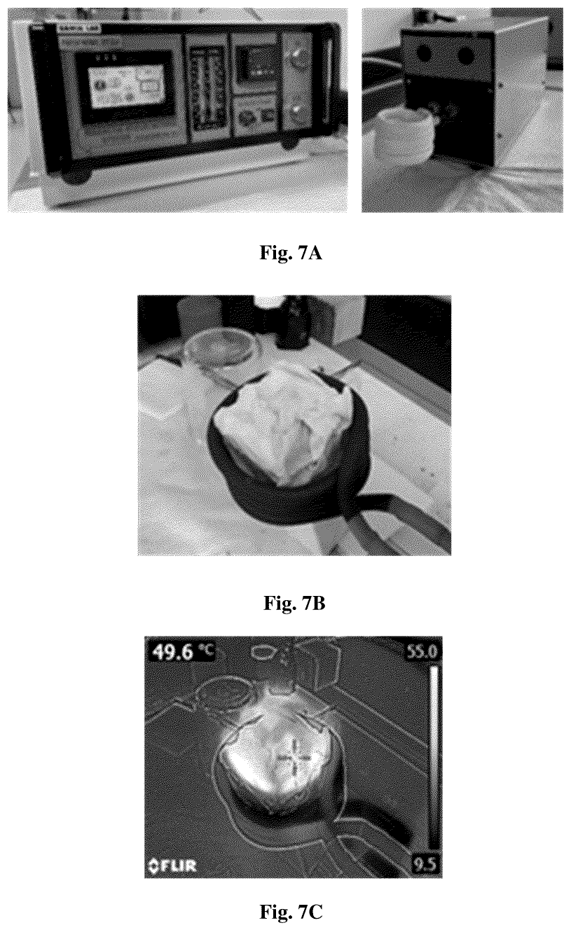

By way of example, as illustrated in FIG. 7(A-C) in a typical AMF-heat curing process, the cement mortars containing MNPs can be carefully demolded after 24 hours of room temperature curing. The samples can then be centered inside the induction coil of the magnetic hyperthermia system (FIG. 7A). A thermal handheld IR camera can be used to monitor the sample temperature throughout the process (FIG. 7B). Additionally, embedded thermocouples can be used to monitor internal temperature. The AMF can operate at 380 kHz with a maximum field strength of 30 kA/m, generating heat within the samples. The field can be activated until the samples reach 50° C., at which point the temperature can be maintained for the designated time. To sustain the target temperature, the initial field strength of 30 kA/m will be gradually reduced and maintained at 15 kA/m. A continuous AMF activation for 1.5 hours can ensure steady and uniform heat curing.

The AMF-cured concrete composition, including MNP inclusions, may have a compressive strength of at least about 5 MPa, about 5 MPa to about 120 MPa, about 10 MPa to about 110 MPa, about 20 MPa to about 100 MPa, about 30 MPa to about 90 MPa, about 40 MPa to about 80 MPa, about 50 MPa to about 70 MPa, or about 120 MPa. The AMF-cured concrete composition may have an increased compressive strength of at least about 0%, about 0% to about 50%, about 5% to about 45%, about 10% to about 40%, about 15% to about 35%, about 20% to about 30%, or about 50% or more over the compressive strength of a cured concrete composition without MNP inclusions. The ability of the MNPs to maintain or increase the compression strength of a concrete composition comprising MNP inclusions may vary depending on parameters used to prepare the MNPs, including, but not limited to, amount, shape, size, surface functionalization, source, or a combination thereof.

Advantageously, the AMF curable concrete composition, including the curable cementitious material, MNPs, aggregate materials, and other supplemental materials, can be blended to make concrete, ready mix concrete, high performance concrete (HPC), ultrahigh performance concrete (UHPC), self-consolidating concrete (SCC) (also known as self-compacting concrete), bagged concrete, bagged cement, mortar, bagged mortar, grout, bagged grout, molding compositions, bagged molding compositions, or other fresh or dry cementitious compositions known in the art, whose cure time, mechanical strength, and durability can be controlled by AMF heating of the MNPs.

In some embodiments, the AMF curable concrete composition can be used to manufacture concrete and other cementitious compositions that can be used in adverse cold weather environments, where moisture loss and freezing temperatures can significantly hinder hydration, and in space applications. In such environments, heat curing becomes a crucial method for mitigating cracking, preventing strength loss, and accelerating the curing process. In space applications, concrete curing presents additional challenges, including moisture evaporation under vacuum conditions and extreme temperature fluctuations.

In other embodiments, the AMF curable concrete composition can be used to provide rapidly cured mortars that are sufficiently stiff to support the weight of a brick or concrete block. In other embodiments, the AMF curable concrete composition can be used to provide oil well cements that can be continuously blended and pumped into a well bore and then cured by AMF. In other embodiments, the AMF curable concrete composition can be used to provide grout that is used to fill in spaces, such as cracks or crevices in concrete structures, spaces between structural objects, and spaces between tiles and cured by AMF heating. In still other embodiments, the AMF curable concrete composition can be used to provide molding compositions that are used to manufacture molded or cast objects, such as pots, troughs, posts, walls, floors, fountains, countertops, sinks, ornamental stone, building facades, and the like, that can be cured by AMF heating.

The following example is included to demonstrate preferred embodiments of the invention. It should be appreciated by those of skill in the art that the techniques disclosed in the example, which follow represent techniques discovered by the inventor to function well in the practice of the invention, and thus can be considered to constitute preferred modes for its practice. However, those of skill in the art should, in light of the present disclosure, appreciate that many changes can be made in the specific embodiments which are disclosed and still obtain a like or similar result without departing from the spirit and scope of the invention.

### Example

We developed a scalable solvothermal synthesis approach to produce shape-anisotropic magnetic nanoparticles (MNPs). Compared to isotropic spherical MNPs, anisotropic nanoparticles, particularly those with cubic geometry, exhibit a greater effective surface area and higher magnetocrystalline anisotropy energy, which enhances heating efficiency upon alternating magnetic field (AMF) activation. Studies have shown that anisotropic MNPs, such as nanocubes and nanorods, generate more heat under AMF due to their increased hysteresis losses and specific absorption rates (SAR), making them highly effective for thermal applications.

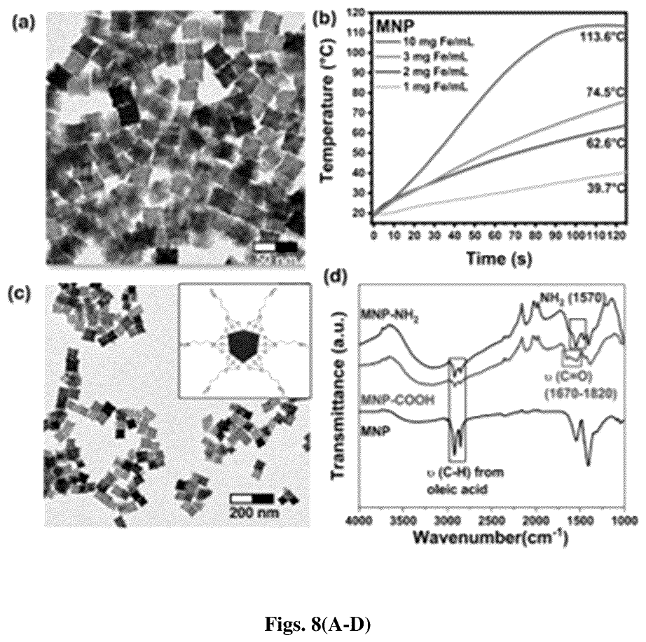

FIG. 8A is a representative TEM image of multicore cubic-shaped magnetite (Fe₃O₄) MNPs synthesized as described herein, along with the corresponding heat curves upon excitation by an AMF (FIG. 8B). These tailored MNPs can serve as functional fillers in concrete formulations, allowing precise control over their thermal and mechanical properties. Moreover, the improved mechanical performance in nanoparticle-incorporated blended cement (BC) mortars is strongly linked to the interfacial interactions between the nanoparticles and the cementitious matrix.

To tune the surface chemistry of the MNPs, we developed a silane-based ligand exchange process that enables the functionalization of MNP surfaces with amine-or carboxy-terminating chemical groups (FIG. 8C). These surface-modified nanoparticles, as confirmed by Fourier Transform Infrared (FTIR) spectroscopy, with characteristic vibrational stretch peaks for NH2 (1570 cm⁻¹) and C═O (1670-1820 cm⁻¹) (FIG. 8D), exhibit strong molecular interactions with hydration products. Advantageously, amine-functionalized MNPs can promote strong bonding with calcium silicate hydrate (C—S—H), improving the mechanical properties of cementitious materials through enhanced interfacial adhesion. Importantly, the surface modification process preserves nanoparticle morphology, ensuring that the MNPs retain their size and shape.

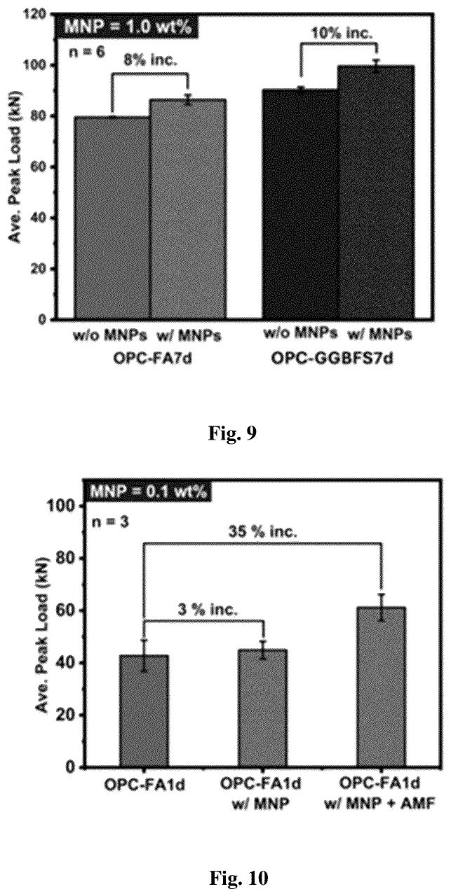

We demonstrated the feasibility of using MNPs to enhance the performance of BC mortar. 50-mm cube samples, with or without the addition of cubic-shaped MNPs, were fabricated using Type I/II Ordinary Portland Cement (OPC), partially replaced with either 30% FA or GGBFS, fine aggregate, and water using brass molds (FIG. 9). We demonstrated that incorporating amino-silane-capped MNPs at even a low concentration of 1 % wt. with respect to the binder resulted in an 8% and 10% improvement in the mechanical performance of 50-mm mortar cubes prepared with FA-based and GGBFS-based BC, respectively (FIG. 9)

Furthermore, activating OPC-FA mortar containing 0.1 % wt. of MNPs with an AMF led to a remarkable 35% enhancement in mechanical performance within a one-day curing period (FIG. 10). This finding demonstrates that AMF induction heating of MNPs embedded in cementitious materials can accelerate hydration and pozzolanic reaction leading to strength gain.

From the above description of the invention, those skilled in the art will perceive improvements, changes and modifications. Such improvements, changes and modifications within the skill of the art are intended to be covered by the appended claims. All references, publications, and patents cited in the present application are herein incorporated by reference in their entirety.

Having described the invention, we claim:

1. A curable concrete composition, comprising:
a curable cementitious material and a plurality of magnetic nanoparticles (MNPs) dispersed in the curable cementitious material, wherein the MNPs generate heat upon application of an electromagnetic field to the composition, effective to reduce cure time of the curable concrete composition, and/or enhance mechanical strength and/or durability of a cured concrete composition formed from the curable concrete composition.

2. The curable concrete composition of claim 1, comprising about 0.001% to about 5% by weight MNPs.

3. The curable concrete composition of claim 2, wherein the MNPs after application of the electromagnetic field maintain their superparamagnetic behavior without remanence.

4. The curable concrete composition of claim 3, wherein the MNPs having a cubic or cuboid shape and a spinel crystal structure.

5. The curable concrete composition of claim 4, wherein the MNPs have an average diameter of about 10 nm to about 30 nm.

6. The curable concrete composition of claim 5, wherein the MNPs include at least one of magnetite (Fe₃O₄) or zinc-doped magnetite (ZnₓFe₃₋ₓO₄), where 0<x≤1.

7. The curable concrete composition of claim 6, wherein the MNPs are surface functionalized with one or more ligands to enhance pozzolanic reactions with the curable cementitious material and facilitate intermolecular interactions with cementitious hydration products of the composition.

8. The curable concrete composition of claim 6, wherein the MNPs comprise hydrothermally carbonized, cubic-shaped MNP nano-chains.

9. The curable concrete composition of claim 6, further comprising an aggregate material dispersed in the curable cementitious material.

10. The curable concrete composition of claim 6, wherein the curable cementitious material comprises a cement and at least one of a supplementary cementitious material or an alkali activatable material.

11. The curable concrete composition of claim 10, wherein the supplementary cementitious material provides a source of at least a portion of the MNPs in the curable concrete composition.

12. A method of modulating curing of a curable concrete composition, the method comprising:
dispersing a plurality of magnetic nanoparticles (MNPs) in the curable concrete composition, wherein the MNPs generate heat upon application of an electromagnetic field; and
applying an electromagnetic field to the curable concrete composition, effective for the dispersed MNPs to generate heat and at least partially cure the curable concrete composition.

13. The method of claim 12, wherein the electromagnetic field is an alternating magnetic field that is applied at a magnetic field amplitude and frequency effective to heat the curable concrete composition to a temperature of about 40° C. to about 60° C.

14. The method of claim 13, wherein the alternating magnetic field is applied at a magnetic field amplitude of about 1 kA/m to about 500 kA/m and a frequency of about 100 kHz to about 1 MHz.

15. The method of claim 14, wherein the curable concrete composition includes a curable cementitious material, an aggregate, and optionally water, wherein the curable cementitious material includes a cement and supplementary cementitious material.

16. The method of claim 15, wherein MNPs are dispersed in water and the dispersion of MNPs and water is mixed with the curable cementitious material and aggregate.

17. The method of claim 16, wherein the MNPs are dispersed in the curable concrete composition at an amount of about 0.001% to about 5% by weight MNPs.

18. The method of claim 17, wherein the MNPs comprise iron oxide magnetic nanocubes, which are optionally doped with zinc, the iron oxide magnetic nanocubes having a spinel crystal structure and an average diameter of about 10 nm to about 30 nm.

19. The method of claim 18, wherein the MNPs are surface functionalized with one or more ligands to enhance pozzolanic reactions with the curable cementitious material and facilitate intermolecular interactions with cementitious hydration products of the composition; or
wherein the MNPs comprise hydrothermally carbonized, cubic-shaped MNP nano-chains.

20. The method of claim 17, wherein the supplementary cementitious material provides a source of at least a portion of the MNPs dispersed in the curable concrete composition.
